(19) United States
(12) Patent Application Publication
(10) Pub. No.: US 2023/0287213 A1
(43) Pub. Date: Sep. 14, 2023

(54) THERMALLY CONDUCTIVE COMPOSITION, CURED PRODUCT AND ELECTRONIC COMPONENT

(71) Applicant: RESONAC CORPORATION, Tokyo (JP)

(72) Inventors: Hajime FUNAHASHI, Tokyo (JP); Hikaru SATOH, Tokyo (JP); Hajime YUKUTAKE, Tokyo (JP); Ikue KOBAYASHI, Tokyo (JP); Takeshi IEMURA, Tokyo (JP)

(73) Assignee: RESONAC CORPORATION, Tokyo (JP)

(21) Appl. No.: 18/119,063

(22) Filed: Mar. 8, 2023

(30) Foreign Application Priority Data
Mar. 9, 2022 (JP) 2022-036565

(51) Int. Cl. C08L 75/04; C08L 33/08; C08K 3/22; C08K 3/28; C08K 9/06

(52) U.S. Cl. CPC C08L 75/04; C08L 33/08; C08K 3/22; C08K 3/28; C08K 9/06; C08K 2003/2227; C08K 2003/282; C08K 2201/014; C08L 2203/20; C08K 2201/003

(57) ABSTRACT

A thermally conductive composition containing a filler and a polymer component, wherein the filler includes a filler (A) surface-treated with a silylated castor oil derivative obtained by reacting isocyanate silane with a castor oil-based polyol.

### FIELD OF THE INVENTION

The present invention relates to a thermally conductive composition, a cured product of the thermally conductive composition and an electronic component.

### BACKGROUND OF THE INVENTION

Removal of heat from heat generating bodies has been an issue in various fields. Removal of heat particularly from heat generating electronic components such as electronic devices, personal computers, and engine control units (ECUs) for automobiles, and batteries has been an important issue. Accompanying increased capability of heat generating components, the amount of heat generated from the generating components tends to increase, and thus heat dissipation materials having a high thermal conductivity have been used as a measure against heat.

Silicone materials facilitate synthesis of low-viscosity polymers, and their cured products relatively facilitate adjustment of cross-linking points, thereby making it easy to create heat dissipation materials having a low hardness and a high thermal conductivity.

However, silicone materials include low-molecular siloxanes. The siloxane is vaporized to cause a conductive failure or the like, and thus use thereof is often discouraged. For this reason, materials having a high thermal conductivity other than silicone materials and those additionally having a low hardness, have been required in order to protect electronic components from vibration.

As a thermally conductive filler, grease, a heat dissipation sheet, an adhesive, and the like, are used, in which a thermally conductive filler is added to an elastomer such as a urethane-based material. However, there are few non-silicone heat dissipation materials with a low hardness and a high thermal conductivity.

In order to increase the thermal conductivity of the heat dissipation material, it is easy and significantly effective as well to increase the amount of filler having thermal conductive, to be filled. However, there are few non-silicone materials with a low viscosity, thereby making it difficult to adjust cross-linking points. A possible means for adding a plasticizer in order to lower a viscosity and increase the content of a filler to be filled is contemplated, however, adding a large amount of plasticizer results in problems such as a decrease in heat resistance of a cured product.

Surface treatment of a filler has been proposed as a method for facilitating filling with a filler. For example, silane coupling agents such as an alkoxysilane with a long-chain aliphatic group and higher fatty acid are used as surface treatment agents. The silane coupling agent has an alkoxy group in its molecule that bonds to a filler surface as well as a hydrophobic group that bonds to a polymeric material, which plays a role to bond between the filler and the polymeric material.

JP-A-2007-56067 discloses an electrically insulating, flame-retardant, thermally conductive material containing acrylic liquid rubber, a flame retardant, and thermally conductive electrical insulating agents such as alumina and crystalline silica and also discloses that further containing an alkoxysilane coupling agent having a long-chain aliphatic alkyl group improves flexibility and heat resistance.

Meanwhile, JP-A-H10-182671 discloses that an attempt was made to improve the physical properties of a curable composition, resulting in that a curable composition containing silylated castor oil in which hydrogen of a hydroxyl group of the castor oil is replaced with a silyl group of a specific structure, a polyol, and a polyisocyanate, has a low viscosity. Design of moisture-curable adhesive from vegetable oils and fats and effects of cross-linked structure on hydrolysis resistance “Network Polymers” Vol. 34, No. 3 (2013) also discloses that a curable resin containing an alkoxysilyl group, an ester group, and a urethane group in the molecule, obtained by reacting castor oil and isocyanate silane, has favorable curability and excellent hydrolysis resistance when a Lewis acid catalyst is used as a curing agent.

### SUMMARY OF THE INVENTION

### Technical Problem

Increase in the number of carbon atoms of a hydrophobic group in a silane coupling agent makes it difficult to hydrolyze an alkoxy group which causes it difficult to prepare a solution in which a filler is dispersed and causes a large amount of unreacted silane coupling agent leaved in the polymer system, resulting in problems such as contamination of an apparatus by vaporization, and lowering of heat resistance of a heat dissipation material. In the composition of JP-A-2007-56067, the compatibility of liquid acrylic rubber and a silane coupling agent having a long-chain alkyl group is relatively favorable, which, however, limits the amount of filler to be filled. In other words, a surface treatment agent capable of increasing the amount of filler to be filled even for polar materials represented by acrylic polymers and urethane polymers, has been required.

Meanwhile, JP-A-H10-182671 refers to no application of silylated castor oil itself to surface treatment of filler. In addition, Design of moisture-curable adhesive from vegetable oils and fats and effects of cross-linked structure on hydrolysis resistance “Network Polymers” Vol. 34, No. 3 (2013) also describes no methods at all, for applying a curable resin derived from castor oil to surface treatment of filler.

The present invention has been made in view of these circumstances, and it is an object thereof to provide a thermally conductive composition that can give a cured product having an excellent thermal conductivity as well as a large consistency and a low hardness, a cured product thereof, and an electronic component including the cured product.

### Solution to Problem

The present inventors have made intensive studies and have conceived of applying a specific silylated castor oil derivative to surface treatment of filler, to find that the problems can be solved by the following invention.

That is, the present disclosure relates to the following.
[1] A thermally conductive composition containing a filler and a polymer component, wherein the filler includes a filler (A) surface-treated with a silylated castor oil derivative obtained by reacting isocyanate silane with a castor oil-based polyol.
[2] The thermally conductive composition according to the above [1], wherein the isocyanate silane includes one or two selected from (3-isocyanatopropyl)triethoxysilane and (3-isocyanatopropyl)trimethoxysilane.
[3] The thermally conductive composition according to the above [1] or [2], wherein the filler (A) has a volume cumulative particle diameter D50 of 0.03 to 10 μm.
[4] The thermally conductive composition according to any one of the above [1] to [3], further containing, as the filler, a thermally conductive filler (B) not surface-treated with a silylated castor oil derivative.
[5] The thermally conductive composition according to the above [4], wherein the filler (B) has a volume cumulative particle diameter D50 of 10 to 300 μm.
[6] The thermally conductive composition according to the above [4] or [5], wherein the filler (B) is aluminum oxide, or aluminum nitride having a silicon-containing oxide coating on the surface thereof.
[7] The thermally conductive composition according to any one of the above [1] to [6], which is in liquid form.
[8] The thermally conductive composition according to any one of the above [1] to [7], wherein the polymer component is free of a silicone polymer, or a content of the silicone polymer in the polymer component is less than 50% by mass.
[9] The thermally conductive composition according to any one of the above [1] to [8], having a consistency at 23° C. of 250 to 400, measured in accordance with JIS K2220:2013.
[10] A cured product of the thermally conductive composition according to any one of the above [1] to [9].
[11] The cured product according to the above [10], having a thermal conductivity of 0.5 W/mK or more, measured in accordance with ISO 20020-2.
[12] The cured product according to the above [10] or [11], having an Asker C hardness of 10 to 95, measured in accordance with JIS K7132:1996.
[13] An electronic component including the cured product according to any one of the above [10] to [12].
[14] The electronic component according to the above [13], wherein the electronic component is a heat dissipation sheet.

### Advantageous Effects of Invention

According to the present invention, it is possible to provide a thermally conductive composition that can give a cured product having an excellent thermal conductivity as well as a large consistency and a low hardness, a cured product thereof, and an electronic component including the cured product.

### DETAILED DESCRIPTION OF THE INVENTION

Hereinbelow, the present invention will be described in detail with reference to one embodiment.

The term “castor-oil based” herein means natural oils and fats and processed natural oils and fats containing a triester compound of ricinoleic acid and glycerin, or synthetic oils and fats containing a triester compound obtained by synthesis. The term “castor oil-based polyol” means an ester compound of ricinoleic acid and/or hydrogenated ricinoleic acid and polyhydric alcohol (glycerin, ethylene glycol, etc.). The ester compound may be a compound modified using castor oil obtained by pressing seeds of castor (castor bean, academic name: Ricinus communis L.) or a derivative thereof as a starting material, or may be a polyol obtained by using a raw material other than castor oil as a starting material.

The term “in liquid form” in the present invention means having a consistency at 23° C. of 250 or more. The consistency can be measured by a method in accordance with JIS K2220: 2013, and specifically by the method described in examples.

The silicone polymer in the present invention means a polymer having at least a moiety of siloxane bonds.

The thermally conductive composition of the present embodiment is a thermally conductive composition containing a filler and a polymer component, wherein the filler includes a filler (A) (hereinbelow may be simply referred to as the “filler (A)”) surface-treated with a silylated castor oil derivative obtained by reacting isocyanate silane with a castor oil-based polyol (hereinbelow may be simply referred to as the “silylated castor oil”).

### [Filler (A)]

### <Silylated Castor Oil Derivative>

The silylated castor oil derivative can be obtained by reacting isocyanate silane with a castor oil-based polyol. “Silylated” herein means introducing (or having introduced) an alkoxysilane structure.

### <Isocyanate Silane>

Isocyanate silane is a compound having an isocyanato group and an alkoxysilane structure in one molecule. Reaction of an isocyanato group of the isocyanate silane with a hydroxyl group of castor oil can give a silylated castor oil derivative. In other words, a silylated castor oil derivative having an alkoxysilane structure enables reaction with a hydroxyl group on a filler surface and can be used as a surface treatment agent of the filler.

The isocyanate silane is, for example, an isocyanate alkoxysilane and specific examples thereof include isocyanate silanes having a trialkoxysilane structure, such as (3-isocyanatopropyl)triethoxysilane and (3-isocyanatopropyl)trimethoxysilane.

The isocyanate silane preferably includes one or two selected from (3-isocyanatopropyl)triethoxysilane and (3-isocyanatopropyl)trimethoxysilane. The content of each of one or two selected from (3-isocyanatopropyl)triethoxysilane and (3-isocyanatopropyl)trimethoxysilane in the total amount of isocyanate silanes is preferably 60% by mass or more, more preferably 80% by mass or more, further preferably 100% by mass.

### <Castor Oil-Based Polyol>

The castor oil-based polyol used in the present embodiment is an ester compound of ricinoleic acid and/or hydrogenated ricinoleic acid and a polyhydric alcohol (glycerin, ethylene glycol, etc.). The polyol may be a polyol obtained using castor oil as a starting material or may be a polyol obtained using a raw material other than castor oil, as a starting material as long as the polyol has this configuration. The polyhydric alcohol is not particularly limited, but is, for example, from a divalent alcohol to a hexavalent alcohol, preferably from a divalent alcohol to a tetravalent alcohol, more preferably at least one of glycerin and ethylene glycol, further preferably glycerin.

The number of hydroxyl groups of the castor oil-based polyol is preferably 1 or more and 6 or less. The number of hydroxyl groups is more preferably 1 or more and 3 or less, further preferably 1 or more and 2 or less. The number of hydroxyl groups being 6 or less inhibits a polymer from excessively having cross-linking points with the polymer and increasing the hardness thereof too much.

All of the hydroxyl groups of the castor oil-based polyol is preferably silylated. This prevents the remaining hydroxyl groups from undergoing exchange reaction with an alkoxide in an alkoxysilyl group and increasing the number of silanol groups in the system, thereby improving storage stability.

The alkoxy group (trialkoxy group) of the silylated castor oil derivative, which is used for surface treatment of filler is significantly preferably monofunctional. This prevents bonding of the treated filler to a polymer.

In this case, the hydroxyl group that the castor oil has is preferably absent in the silylated castor oil derivative. This prevents the remaining hydroxyl groups from undergoing exchange reaction with an alkoxide in the alkoxysilyl group and increasing the number of silanol groups in the system, thereby improving storage stability.

Note, however, the hydroxyl value and acid value described above are values measured in accordance with JIS K0070: 1992, and can be specifically measured as described in examples.

The term “the number of hydroxyl groups” herein means an average number of hydroxyl groups contained in one molecule of a castor oil-based polyol and may take a value after the decimal point such as 1.5. The number of hydroxyl groups can be calculated using the following formula.

Number of hydroxyl groups=molecular weight/hydroxyl group equivalent=molecular weight/(56100/hydroxyl value)

Here, 56100 means a value representing the molecular weight of potassium hydroxide as milligrams thereof.

The viscosity at 25° C. of the castor oil-based polyol is preferably from 20 to 300 mPa·s, more preferably from 30 to 250 mPa·s, further preferably from 50 to 200 mPa·s, still further preferably 50 to 100 mPa·s. When the viscosity is within the above range, the resulting silylated castor oil derivative is likely to react with a hydroxyl group on a filler surface, resulting in a tendency to facilitate surface treatment of the filler.

The viscosity is a value measured at 25° C. based on JIS Z8803:2011 “Methods for viscosity measurement of liquid” using a rotary viscometer. Specifically, the value was measured at 25° C. using a BM-type viscometer (manufactured by Toki Sangyo Co., Ltd., trade name: B-10) under conditions of rotor Nos. from 1 to 4 and a rotation rate of 60 rpm. As a rule of thumb, an object with a viscosity of 1 or more and less than 100 mPa·s can be measured with a rotor No. 1, an object with a viscosity of 100 mPa·s or more and less than 500 mPa·s can be measured with a rotor No. 2, an object with a viscosity of 500 mPa·s or more and less than 2000 mPa·s can be measured with a rotor No. 3, and an object with a viscosity of 2000 mPa·s or more and 10000 mPa·s or less can be measured with a rotor No. 4.

Examples of the castor oil-based polyol include polyols produced using castor oil, castor oil fatty acid, hydrogenated castor oil obtained by hydrogenation of castor oil, or hydrogenated castor oil fatty acid obtained by hydrogenation of castor oil fatty acid. Examples thereof further include transesterified products of castor oil and other natural fats and oils, reaction products of castor oil and polyhydric alcohol, esterification reaction products of castor oil fatty acid and polyhydric alcohol, hydrogenated castor oil, transesterified products of hydrogenated castor oil and other natural fats and oils, reaction products of hydrogenated castor oil and polyhydric alcohol, esterification reaction products of hydrogenated castor oil fatty acid and polyhydric alcohol, and polyols having alkylene oxide addition-polymerized thereto. These may be used singly or in admixture of two or more.

The castor oil-based polyol can be produced in accordance with a known production method.

A method for reacting isocyanate silane with a castor oil-based polyol is not particularly limited. For example, a castor oil-based polyol derivative can be obtained by preliminarily dehydrating a castor oil-based polyol by heating it under reduced pressure, and then adding isocyanate silane and a reaction accelerator as described below as required under a nitrogen atmosphere and reacting the mixture under heating. The heating temperature is, for example, from 90 to 130° C. and preferably from 100 to 110° C. The heating time is, for example, from 1 to 10 hours and preferably from 4 to 8 hours. The reaction is preferably carried out in the presence of a catalyst such as dioctyl tin monodecanate.

The completion of the reaction can be confirmed, for example, by confirming the disappearance of an isocyanato group (2265 cm⁻¹) by infrared analysis.

### <Untreated Filler>

The volume cumulative particle diameter D50 of the filler used in the present embodiment, which is subjected to surface treatment with a silylated castor oil derivative (hereinbelow, may be referred to as “untreated filler”) is preferably 0.03 μm or more and 10 μm or less, more preferably 0.1 μm or more and 10 μm or less, further preferably 0.2 μm or more and 10 μm or less.

The term “volume cumulative particle diameter D50” herein is a particle size at an integrated volume of 50% in a certain particle size distribution and can be determined from the particle size at an integrated volume of 50% (50% particle diameter: D50) in a particle size distribution measured using a laser diffraction-type particle size analyzer (for example, manufactured by MicrotracBEL Corp., trade name: MT3300EXII), and specifically can be measured by the method described in examples.

The untreated filler preferably has a thermal conductivity thereof of 1 W/m·K or more from the viewpoint of imparting thermally conductive properties.

Examples of the untreated fillers include ferrite, graphite, metallic powder; oxides, nitrides, carbides, and hydroxides of metals, silicon, or boron. Examples of the oxides include zinc oxide, aluminum oxide, magnesium oxide, silica, and quartz powder, and examples of the nitrides include aluminum nitride, boron nitride, and silicon nitride. Examples of the carbides include silicon carbide and boron carbide, and examples of the hydroxides include aluminum hydroxide, magnesium hydroxide, and iron hydroxide. These may be used singly or in admixture of two or more.

In consideration of the balance between thermal conductivity and cost, aluminum oxide (alumina) is preferable and a-alumina is particularly preferable. A filler such that the thermal conductivity of the untreated filler itself is higher than that of a base polymer, is also preferable.

Aluminum nitride and boron nitride are suitably used from the viewpoint of a high thermally conductive property, while silica, quartz powder, and aluminum hydroxide are suitable for use from the viewpoint of low cost.

The shape of the untreated filler is not particularly limited as long as being particulate, and examples thereof includes true-spherical, spherical, rounded, scaly, and crushed. These may be used in combination.

The specific surface area of the untreated filler, as determined by the BET method, is preferably from 0.05 to 10.0 m²/g, more preferably from 0.06 to 9.0 m²/g, further preferably from 0.06 to 8.0 m²/g. When the specific surface area is 0.05 m²/g or more, high filling with a filler is enabled, and the thermally conductive properties can be enhanced. When the specific surface area is 10.0 m²/g or less, the thermally conductive composition becomes to be integrated well.

The specific surface area of the untreated filler can be measured using a specific surface area measurement apparatus by the single point BET method based on nitrogen adsorption, and specifically can be measured by the method described in examples.

Examples of the surface treatment method of the filler by a silylated castor oil derivative include a dry method, a wet method, and an integral blend method, and any one of the methods may be used.

Here, the dry method in surface treatment of untreated filler is a method in which a predetermined amount of the surface treatment agent, as is or in a form of solution obtained by diluting the agent with an organic solvent, is mechanically mixed while sprayed or dropped into the filler, and then drying and baking of the surface treatment agent are performed as required. The wet method is a method in which a filler is impregnated with a solution obtained by diluting a predetermined amount of the surface treatment agent with an organic solvent and is subjected to stirring and mixing to volatilize the solvent. The integral blend method is a method in which a predetermined amount of the surface treatment agent is added while the polymer and the filler are mixed. Generally in the integral blend method, in view of reactivity with the filler, a relatively large amount of the surface treatment agent is often used, and further, the mixing is often performed under heating.

With increasing the molecular weight of a silylated castor oil derivative, hydrolysis reaction of the alkoxysilyl group of a silylated castor oil derivative is likely to be slowed down, which thereby also tends to slow down the reaction rate with the hydroxyl group on a surface of an untreated filler. Therefore, heating is preferred. The integral blend method can inhibit foaming by heating. The heating temperature and time is preferably from 120° C. to 150° C. for 2 to 8 hours for the dry method, and is preferably from 80° C. to 150° C. for 2 to 12 hours for the integral blend method.

The amount of silylated castor oil derivative used is preferably from 0.05 to 5% by mass, more preferably from 0.08 to 3% by mass, further preferably from 0.1 to 2% by mass based on the total amount of the untreated filler. The amount of silylated castor oil derivative used being too few does not reduce the viscosity of a composition, and the amount of silylated castor oil derivative used being too much allows a cured product to become too soft and not to retain the shape of the cured product.

Examples of a surface treatment apparatus include a rotation-revolution stirring mixer, a blender, a nauta, a Henschel mixer, and a planetary mixer, and any of these may be used.

The untreated filler may be a combination of plurality of fillers as long as untreated fillers having a different particle size distribution each have a preferred volume cumulative particle diameter D50 described above, from the viewpoint of thermally conductive properties. For example, the untreated filler may be a combination of a filler having a volume cumulative particle diameter D50 of 0.03 μm or more and less than 0.8 μm as an untreated filler (a1) and a filler with a volume cumulative particle diameter D50 of 0.8 μm or more and 10 μm or less as an untreated filler (a2).

The volume cumulative particle diameter D50 of the untreated filler (a1) is preferably 0.04 μm or more and 0.8 μm or less and more preferably 0.1 μm or more and 0.7 μm or less.

The volume cumulative particle diameter D50 of the untreated filler (a2) is preferably 0.9 μm or more and 10 μm or less and more preferably 1.0 μm or more and 10 μm or less.

### [Polymer Component]

The thermally conductive composition of the present embodiment is preferably such that the polymer component is free of a silicone polymer, or the content of a silicone polymer in the polymer component is less than 50% by mass. This prevents siloxane derived from the silicone polymer from being vaporized to cause a conductive failure or the like, and also allows the composition to be favorably compatible with a silylated castor oil derivative.

Moreover, the polymer component is preferably a polymer component that is compatible with the silylated castor oil derivative described above in the thermally conductive composition. This improves the filling properties of a filler, increases the consistency of the composition, and reduces the hardness of a cured product.

The polymer component used in the thermally conductive composition of the present embodiment is more preferably a polymer component that is free of a silicone polymer. This firmly prevents siloxane derived from the silicone polymer from being vaporized to cause a conductive failure or the like.

Examples of the polymer components described above that are free of a silicone polymer include fluorine-based polymers such as polytetrafluoroethylene (PTFE), a copolymer of tetrafluoroethylene and perfluoro (alkyl vinyl ether) (PFA); polyolefins such as an ethylene-propylene-diene copolymer (EPDM) and polyisobutylene; polyethers such as polypropylene oxide; acrylic polymers; and urethane polymers or a combination of a polyol and a polyisocyanate compound that constitute the urethane polymer.

Of these, the acrylic polymer, urethane polymer, or the combination of a polyol and a polyisocyanate compound constituting the urethane polymer, are preferred, from the viewpoint of availability thereof and the like. They will be described in detail below.

### <Acrylic Polymer>

Examples of the acrylic polymer include an acrylic resin that is curable, for example, by light or heat, and an acrylic resin for resists, preferably an acrylic resin, acrylic rubber or the like that is in liquid form, can be suitably used.

The viscosity of the acrylic resin at 25° C. is preferably from 20 to 15000 mPa·s, more preferably from 50 to 3000 mPa·s, from the viewpoint of the filling properties of a filler and the low viscosity of a composition.

The acrylic polymer is preferably used together with a curing agent. The curing agent is preferably a compound that exhibits curability by light or heat and examples thereof include peroxides such as bis(4-tert-butylcyclohexan-1-yl) peroxydicarbonate and benzoyl peroxide.

For example, an acrylic resin or acrylic rubber that is in liquid form is obtained by mixing one, two or more of polymers copolymerized with one, two or more of an acrylic acid alkyl ester with an alkyl group having from 2 to 12 carbon atoms, from the viewpoints of flexibility, adhesiveness and processability. Examples of the acrylic acid alkyl esters preferably include ethyl acrylate, n-butyl acrylate, and 2-ethylhexyl acrylate.

The acrylic resin or acrylic rubber that is in liquid form, may contain 10% by mass or less of units based on a crosslinkable monomer containing epoxy groups such as glycidyl acrylate, glycidyl methacrylate, allyl glycidyl ether, and meta-allyl glycidyl ether in terms of flexibility and heat resistance. The acrylic resin or acrylic rubber may also be such that it is copolymerized with other monomers which can be copolymerized with the monomers described above, such as an acrylic acid alkoxyalkyl ester, fluorine-containing acrylic acid ester, hydroxyl group-containing acrylic acid ester, tertiary amino group-containing acrylic ester, methacrylate, alkyl vinyl ketone, vinyl ether, allyl ether, vinyl aromatic compounds such as styrene and a-methylstyrene, ethylenically unsaturated compounds such as acrylonitrile, methacrylonitrile, ethylene, propylene, vinyl chloride, vinylidene dichloride, vinyl fluoride, and vinylidene fluoride, vinyl propionate, and alkyl fumarate, or it may be a reactive acrylic polymer with a reactive group at the side chain or the end.

Liquid acrylic rubber is obtained by copolymerization of the above monomers by known methods such as emulsion polymerization, suspension polymerization, solution polymerization, and bulk polymerization.

Liquid acrylic rubber may be combined with known vulcanizing agents and vulcanization accelerators. The amount thereof added is preferably 5 parts by mass or less and more preferably from 0.1 to 3 parts by mass, based on 100 parts by mass of liquid acrylic rubber.

### <Polyol>

Examples of polyols include a polyester polyol, a polyether polyol, an acrylic polyol, and the castor oil-based polyol described above. They may be used singly or two or more thereof may be combined. Of these, preferable is the acrylic polyol because of its excellent heat resistance, and the castor oil-based polyol is preferable because of its excellent hydrolysis resistance.

Examples of polyol products include a castor oil-based polyol “URIC 3609U,” manufactured by Ito Oil Chemicals Co., Ltd., an acrylic polyol “BPX-003,” manufactured by Negami Chemical Industrial Co., Ltd., and the like.

The number of hydroxyl groups of a castor oil-based polyol when used as a polymer component is preferably more than 1 and 3 or less from the viewpoint of reducing the number of cross-linking points and further preferably 2 or more and 3 or less.

From the viewpoint of curability, the hydroxyl value of the castor oil-based polyol is preferably from 10 to 200 mg KOH/g and more preferably from 15 to 170 mg KOH/g.

Moreover, from the viewpoint of water resistance and heat resistance, the acid value of the castor oil-based polyol is preferably from 0.2 to 5.0 mg KOH/g and more preferably from 0.2 to 3.8 mg KOH/g.

Furthermore, the viscosity of the castor oil-based polyol at 25° C. is preferably from 20 to 300 mPa·s, more preferably from 30 to 250 mPa·s, further preferably from 50 to 200 mPa·s, still further preferably from 50 to 100 mPa·s. The viscosity within the ranges makes it possible to increase the amount of filler to be filled while the physical properties of the castor oil-based polyol are maintained, and to lower the viscosity of the thermally conductive composition.

The content of castor oil-based polyol when used as a polymer component is preferably from 2.0 to 10.0% by mass, more preferably from 2.5 to 9.0% by mass, further preferably from 3.0 to 8.0% by mass based on the total amount of thermally conductive composition. When the content of the castor oil-based polyol is within the range, the thermally conductive composition can be cured, and the cured product can have a hardness within a desired range.

When the castor oil-based polyol is used as a polyol, a polyol other than the castor oil-based polyol may be combined. The content of the polyol other than the castor oil-based polyol is preferably 2.0% by mass or less, more preferably 1.5% by mass or less, further preferably 1.0% by mass or less based on the total amount of the polyol. When the content of the polyol other than the castor oil-based polyol is 2.0% by mass or less, the consistency of the thermally conductive composition can be within a desired range, and additionally, the hydrolytic resistance of a cured product of the thermally conductive composition can be made favorable.

### <Polyisocyanate Compound>

The polyisocyanate compound is a compound having 2 or more isocyanato groups in one molecule. Examples thereof include aromatic polyisocyanates, aliphatic polyisocyanates, and alicyclic polyisocyanates. These may be used singly or in admixture of two or more.

Examples of the aromatic polyisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Examples of the aliphatic polyisocyanate include trimethylene diisocyanate, tetramethylene diisocyanate, hexamethylene diisocyanate (HDI), pentamethylene diisocyanate, 1,2-propylene diisocyanate, 1,3-butylene diisocyanate, dodecamethylene diisocyanate, and 2,4,4-trimethyl hexamethylene diisocyanate.

Examples of the alicyclic polyisocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethyl xylylene diisocyanate.

Additional examples include carbodiimide-modified polyisocyanates, castor oil-modified polyisocyanates, biuret-modified polyisocyanates, allophanate-modified polyisocyanates, polymethylene polyphenyl polyisocyanates (polymeric MDIs), and isocyanurate-modified polyisocyanates of the aromatic polyisocyanates, aliphatic polyisocyanates, and alicyclic polyisocyanates.

Of these, preferable is at least one selected from the group consisting of polymethylene polyphenyl polyisocyanates (polymeric MDIs), carbodiimide-modified diphenylmethane diisocyanates, castor oil-modified diphenylmethane diisocyanates, and allophanate-modified polyisocyanates such as a polyisocyanate in which a polyhydric alcohol was added to hexamethylene diisocyanate or HDI as a base diisocyanate, from the viewpoints of a lower hardness of a cured product of the thermally conductive composition and safety of the polyisocyanate compound itself.

The equivalent ratio [NCO/OH] of isocyanato groups of the polyisocyanate compound to hydroxyl groups of the castor oil-based polyol is preferably from 0.8 to 1.6. The equivalent ratio [NCO/OH] is more preferably from 0.8 to 1.5 further preferably from 1.0 to 1.3. The equivalent ratio within this range renders an excellent hardness in handling as well as favorable hydrolysis resistance.

The content of the polyisocyanate compound is preferably from 0.3 to 1.3% by mass, more preferably from 0.35 to 1.25% by mass, further preferably from 0.4 to 1.2% by mass based on the total amount of the thermally conductive composition. When the content of the polyisocyanate compound is within the range, the thermally conductive composition can be cured, and the cured product can have a hardness within a desired range.

[Thermally Conductive Filler (B) not Surface-Treated with Silylated Castor Oil Derivative]

From the viewpoint of the filling properties and thermally conductive properties, the thermally conductive composition preferably further contains, as a filler, a thermally conductive filler (B) (hereinbelow may be simply referred to as “filler (B)”), not surface-treated with the silylated castor oil derivative.

The volume cumulative particle diameter D50 of the filler (B) is preferably 10 μm or more and 300 μm or less, more preferably exceeding 10 μm and 300 μm or less, further preferably 15 μm or more and 150 μm or less, still further preferably 20 μm or more and 120 μm or less, still further preferably 20 μm or more and 50 μm or less.

The filler (B) may be appropriately selected from the group consisting of oxides, nitrides, carbides, and hydroxides of metals, silicone, or boron and used. In consideration of the balance between thermal conductivity and costs, aluminum oxide (alumina) is preferable. From the viewpoint of highly thermally conductive properties, aluminum nitride and boron nitride is preferable used, and from the viewpoint of low costs, silica, quartz powder, and aluminum hydroxide are preferable used. From the viewpoint of hydrolytic resistance, preferable is aluminum nitride having a silicon-containing oxide coating on the surface thereof (hereinbelow, also referred to as silicon-containing oxide-coated aluminum nitride). Oxide, nitride, and carbide are preferred as fillers used for electronic components from the viewpoint of insulation properties.

The silicon-containing oxide coating may cover partially or the entire surface of the aluminum nitride, and preferably covers the entire surface of the aluminum nitride.

Examples of the “silicon-containing oxide” for the silicon-containing oxide coating and silicon-containing oxide-coated aluminum nitride particles include silica and oxides containing silicone and aluminum.

In the silicon-containing oxide-coated aluminum nitride, the coverage of the silicon-containing oxide coating that covers the surface of the aluminum nitride as determined by LEIS analysis is preferably from 70% or more and 100% or less, more preferably 70% or more and 95% or less, further preferably 72% or more and 90% or less, particularly preferably 74% or more and 85% or less. When the coverage is 70% or more and 100% or less, the moisture resistance is more excellent. When the coverage exceeds 95%, the thermal conductivity may decrease.

The coverage (%) determined by LEIS (Low Energy Ion Scattering) analysis of the silicon-containing oxide coating (SiO₂) that covers the surface of the aluminum nitride can be determined by the following formula:

(S_{Al}(AlN)·S_{Al}(AlN+SiO₂))/S_{Al}(AlN)×100

wherein S_{Al}(AlN) is the area of the Al peak of the aluminum nitride, and S_{Al}(AlN+SiO₂) is the area of the Al peak of the silicon-containing oxide-coated aluminum nitride. The area of the Al peak can be determined from analysis by means of low energy ion scattering (LEIS), which is a measurement method using an ion source and a noble gas as probes. LEIS is a technique using a noble gas of several keV as the incident ion, being an evaluation method permitting a composition analysis of the outermost surface (reference: The TRC News 201610-04 (October 2016)).

An example of a method for forming a silicon-containing oxide coating on aluminum nitride includes a method having a first step of covering the surface of the aluminum nitride with a siloxane compound having a structure represented by the following formula (1), and a second step of heating the aluminum nitride covered with the siloxane compound at a temperature of 300° C. or more and 900° C. or less.

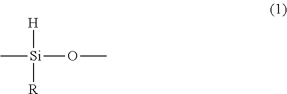

In the formula (1), R is an alkyl group having 4 or less carbon atoms.

The structure represented by the formula (1) is a hydrogen siloxane structural unit having a Si—H bond. In the formula (1), R is an alkyl group having 4 or less carbon atoms, that is, a methyl group, an ethyl group, a propyl group, or a butyl group, preferably a methyl group, an ethyl group, an isopropyl group, or a t-butyl group, more preferably a methyl group.

As the siloxane compound, preferable is an oligomer or a polymer containing a structure represented by the formula (1) as a repeating unit. The siloxane compound may be any of linear, branched, or cyclic. The weight average molecular weight of the siloxane compound is preferably from 100 to 2000, more preferably from 150 to 1000, further preferably from 180 to 500, from the viewpoint of ease of formation of a silicon-containing oxide coating having a uniform coating thickness. The weight average molecular weight is a value in terms of polystyrene, obtained by gel permeation chromatography (GPC).

As the siloxane compound, preferably used are/is a compound represented by the following formula (2) and/or a compound represented by the following formula (3).

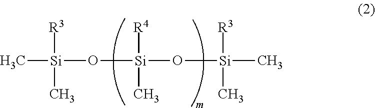

In the formula (2), R³ and R⁴ are each independently a hydrogen atom or a methyl group, and at least either of R³ and R⁴ is a hydrogen atom. m is an integer of 0 to 10, and from the viewpoint of commercial availability and the boiling point, is preferably 1 to 5, more preferably 1.

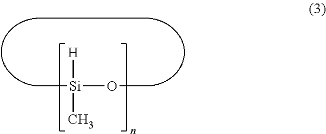

In the formula (3), n is an integer of 3 to 6, preferably from 3 to 5, more preferably 4.

As the siloxane compound, particularly preferable is a cyclic hydrogen siloxane oligomer in which n is 4 in the formula (3), from the viewpoint of ease of formation of a favorable silicon-containing oxide coating.

In the first step, the surface of the aluminum nitride is covered with a siloxane compound having a structure represented by the formula (1).

In the first step, as long as the surface of the aluminum nitride described above can be covered with a siloxane compound having a structure represented by the formula (1), the process is not particularly limited. Examples of the process for the first step include a dry mixing method in which, using a common powder mixing apparatus, dry mixing is made by adding the siloxane compound by spraying while the raw material aluminum nitride is stirred to thereby coat the aluminum nitride.

Examples of the powder mixing apparatus include a Henschel mixer (manufactured by Nippon Coke & Engineering Co., Ltd.), a rotary vessel-type V blender, a ribbon blender having mixing blades such as a double cone-type blender, a screw-type blender, a hermetic rotary kiln, and stirring by means of a stirring bar of a hermetic container using magnet coupling. The temperature conditions are not particularly limited, and are preferably in the range of 10° C. or more and 200° C. or less, more preferably in the range of 20° C. or more and 150° C. or less, further preferably in the range of 40° C. or more and 100° C. or less.

A vapor phase adsorption method also may be used in which vapor of the siloxane compound singly or a mixed gas thereof with an inert gas such as nitrogen gas is caused to be attached or deposited onto the aluminum nitride surface left to stand. The temperature conditions are not particularly limited, and are preferably in the range of 10° C. or more and 200° C. or less, more preferably in the range of 20° C. or more and 150° C. or less, further preferably in the range of 40° C. or more and 100° C. or less. If further necessary, the inside of the system may be pressurized or depressurized. As an apparatus that can be used in this case, preferable is an apparatus which is a hermetic system and in which the gas in the system can be easily replaced. Examples thereof that can be used include a glass container, a desiccator, and a CVD apparatus.

The amount of the siloxane compound used in the first step is not particularly limited. In the aluminum nitride covered with the siloxane compound obtained in the first step, the amount coated with the siloxane compound is preferably 0.1 mg or more and 1.0 mg or less, more preferably in the range of 0.2 mg or more and 0.8 mg or less, further preferably in the range of 0.3 mg or more and 0.6 mg or less per 1 m² of the surface area calculated from the specific surface area (m²/g) of the aluminum nitride determined by the BET method.

The amount coated with the siloxane compound per 1 m² of the surface area calculated from the specific surface area (m²/g) of the aluminum nitride determined by the BET method can be determined by dividing the difference between the masses of the aluminum nitride before and after coated with the siloxane compound by the surface area (m²) calculated from the specific surface area (m²/g) of the aluminum nitride determined by the BET method.

In the second step, the aluminum nitride coated with the siloxane compound obtained in the first step is heated at a temperature of 300° C. or more and 800° C. or less. This enables the silicon-containing oxide coating to be formed on the aluminum nitride surface. The heating temperature is more preferably 400° C. or more, further preferably 500° C. or more.

From the viewpoint that a sufficient reaction time is secured and also a favorable silicon-containing oxide coating is efficiently formed, the heating time is preferably 30 minutes or more and 6 hours or less, more preferably 45 minutes or more and 4 hours or less, further preferably in the range of 1 hour or more and 3.5 hours or less. As for the atmosphere at the time of heating treatment, the heating treatment is preferably performed in an atmosphere containing oxygen gas, for example, in the atmospheric air (in the air).

The particles of the silicon-containing oxide-coated aluminum nitride may be partially fused to one another after the heat treatment in the second step, and in such a case, disintegration using a common pulverizer, for example, a roller mill, a hammer mill, a jet mill, or a ball mill enables silicon-containing oxide-coated aluminum nitride having no sticking and clumping to be obtained.

After completion of the second step, the first step and the second step may be performed in the order mentioned. That is, a step of performing the first step and the second step in the order mentioned may be repeatedly performed.

### [Other Fillers]

The thermally conductive composition of the present embodiment may contain other fillers in addition to the filler (A) and filler (B). The other filler may be a filler before surface treatment with the silylated castor oil derivative, or it may be surface-treated with a surface treatment agent other than the silylated castor oil derivative.

Examples of the surface treatment agent include silane coupling agents other than the above isocyanate silane, a polymer-type (or oligomer-type) silane coupling agent derived from an alkoxysilane, having a viscosity at 25° C. of 10 to 500 mPa·s, titanium coupling agents, aluminum coupling agents, higher alcohols, medium chain fatty acids, long chain fatty acids, fatty acid esters, acidic phosphoric acid esters, phosphorous acid esters, alkylbenzoic acids, and alkylbenzoic acid esters. Surface treatment agents that do not react with the polyisocyanate compound are preferable, and one can be appropriately selected from these and used. These may be used singly or in admixture of two or more.

When a filler (B) is a thermally conductive filler with a volume cumulative particle diameter D50 exceeding 10 μm and 300 μm or less and not surface-treated with a silylated castor oil derivative, the “other filler” may be a filler having a volume cumulative particle diameter D50 of 10 μm or less and not surface-treated with the silylated castor oil derivative.

Any of the dry method, wet method or integral blend method may be employed as a treatment method. When surface treatment of the other fillers is performed by a surface treatment agent other than the silylated castor oil derivative, the amount used is preferably from 0.05 to 5% by mass, more preferably from 0.08 to 3% by mass, further preferably from 0.1 to 2% by mass based on the total amount of the other fillers.

Examples of a surface treatment apparatus include a rotation-revolution stirring mixer, a blender, a nauta, a Henschel mixer, a planetary mixer, and any of these may be used.

The content of the other fillers surface-treated with a surface treatment agent other than the silylated castor oil derivative is preferably 20% by mass or less, more preferably 10% by mass or less, further preferably 0% by mass based on the total amount of the fillers.

### [Dispersant]

When the polymer component in the thermally conductive composition of the present embodiment is a urethane polymer or a combination of a polyol and a polyisocyanate compound, the thermally conductive composition of the present embodiment may further contain a dispersant as required. In particular when containing a filler (B), further containing a dispersant is preferable from the viewpoint of flowability of the thermally conductive composition. Examples of the dispersant include a polymer-type (or oligomer-type) silane coupling agent derived from an alkoxysilane, having a viscosity at 25° C. of 10 to 500 mPa·s, polymeric dispersants, surfactants, wet dispersants, and modified silicone oil. Some of these may have a functional group such as a hydroxyl group, an amino group, an amine salt, or a carboxylate in the molecule such as a silicone skeleton or a hydrocarbon skeleton. These may be used singly or in admixture of two or more.

Examples of commercially available products of the dispersant include “BYK-106” and “BYK-108” manufactured by BYK-Chemie GmbH and “EXP6496D” manufactured by DIC Corporation.

When the dispersant is combined with surface treatment agents such as an alkoxysilane, effects of dispersing a filler and of improving the consistency of the thermally conductive composition may be reduced. Furthermore, the dispersant may react with an isocyanate group, and thus appropriate selection thereof is required.

The dispersant is preferably placed on kneading a filler (B) into the thermally conductive composition. That is, the surface of the filler (B) is preferably treated by the integral blend method.

When the dispersant is further contained, the content thereof is preferably from 0.05 to 5.0 parts by mass, more preferably from 0.1 to 5.0 parts by mass, further preferably from 0.5 to 4.8 parts by mass, still further preferably from 1.0 to 4.8 parts by mass based on 100 parts by mass in total of the polymer components, from the viewpoint of an improvement in the consistency of the thermally conductive composition.

The thermally conductive composition of the present embodiment may additionally contain a reaction accelerator.

The reaction accelerator used in the present embodiment is not particularly limited as long as it accelerates curing reaction of the thermally conductive composition, and examples of the reaction accelerator include organometallic compounds such as organotitanium compounds, organoaluminum compounds, organozirconium compounds, organobismuth compounds, organotungsten compounds, organomolybdenum compounds, organocobalt compounds, organozinc compounds, organopotassium compounds, and organoiron compounds; and amine compounds such as 1,8-diazabicyclo[5.4.0]undecene-7 (DBU) and 1,5-diazabicyclo[4.3.0]nonene-5 (DBN). These may be used singly or in admixture of two or more.

When a surface treatment agent having a trialkoxy group is used as the surface treatment agent for the filler, the surface treatment agent causes a condensation reaction with an organometallic compound, an amine compound, or the like to generate a bond other than polymer and isocyanate. Thus, the hardness of the cured product may increase, or the preservability of the thermally conductive composition may be lowered. In order to prevent these, countermeasures are required to be appropriately taken such as, not adding a reaction accelerator depending on the surface treatment agent, or selection of the surface treatment agent, or removal of water from the system.

When a reaction accelerator is used, the content thereof is preferably from 0.002 to 0.030% by mass, more preferably from 0.004 to 0.025% by mass, further preferably from 0.006 to 0.020% by mass based on the total amount of the thermally conductive composition. When the content of the reaction accelerator is within the range described above, the thermally conductive composition is cured more favorably.

The thermally conductive composition of the present embodiment may further contain a retardant. The retardant is not particularly limited as long as it retards curing reaction of the thermally conductive composition, and examples of the retardant include acidic compounds such as acidic phosphoric acid esters (provided that ones corresponding to flame retardants mentioned below are excluded), phosphorous acid esters, alkylbenzoic acids, alkylbenzoic acid esters, carboxylic acids, and hydrochloric acid. Addition of an unintentionally acidulated filler is also effective. Specific examples thereof include fillers treated with a chlorosilane compound, fillers of which the alkali content is washed with hydrochloric acid or sulfuric acid, fillers treated with phosphoric acid or a phosphoric acid ester, and fillers treated with a fatty acid such as stearic acid.

Here, phosphoric acid, phosphoric acid esters, fatty acids, and the like may be used as a surface treatment agent for the filler. When a filler treated therewith is added, care should be taken because further adding a retardant may prevent progress of curing reaction.

When the retardant is used, the amount thereof added is preferably from 0.001 to 0.5 parts by mass based on 100 parts by mass in total of the polymer components.

The thermally conductive composition of the present embodiment may further contain a plasticizer. Examples of the plasticizer include polymers derived from castor oil having no functional group (provided that castor oil-based polyols are excluded), carboxylic acid esters, polyphosphoric acid esters, trimellitic acid esters, polybutene, and α-olefins. When the thermally conductive composition is caused to contain a plasticizer, the viscosity of the thermally conductive composition can be reduced, and also the hardness of a cured product can be lowered.

When the thermally conductive composition of the present embodiment contains a plasticizer, the content thereof is preferably 50 parts by mass or less, more preferably 30 parts by mass or less based on 100 parts by mass of the polymer components. When the content of the plasticizer is 50 parts by mass or less, it is possible to inhibit occurrence of oil bleeding and weakening of a cured product. The lower limit of the content of the plasticizer is preferably 5 parts by mass.

To the thermally conductive composition of the present embodiment, additives such as a flame retardant, an antifoaming agent, a heat-resistant stabilizer, and a pigment can be blended as required in addition to the components above, without impairing the effects of the present invention.

When the additives are used, the amount of each of the additives added is preferably from 0.1 to 6.0 parts by mass, more preferably from 0.2 to 5.0 parts by mass based on 100 parts by mass in total of the polymer components.

A flame retardant and a heat-resistant stabilizer, which are in liquid form at 23° C. are regarded as polymer components, and then the amount of additives described above will be determined.

Examples of the flame retardant include hydroxides such as calcium hydroxide and magnesium hydroxide; oxides such as molybdenum oxide and boron oxide; carbon; phosphorus compounds; and phosphoric acid compounds such as ammonium phosphate and phosphoric acid esters; provided that ones corresponding to the filler are excluded. These may be used singly or in admixture of two or more.

Note, however, aluminum hydroxide, magnesium hydroxide, and the like can also be used as thermally conductive fillers, and phosphoric acid esters also act as a retardant.

The antifoaming agent is not particularly limited, and examples of thereof include silicone compounds, fluorine compounds, high molecular polymers, and fatty acid esters. Provided that ones corresponding to the dispersant are excluded. Preferable antifoaming agents are ones that do not react with the polyisocyanate compound or the reaction accelerator. These may be used singly or in admixture of two or more.

Examples of the heat-resistant stabilizer include oxides such as zirconium oxide, cerium oxide, or composite oxides thereof (provided that ones corresponding to the filler and the flame retardant are excluded), carbon, phenolic compounds, sulfur compounds, phosphorus compounds, amine compounds, and imidazole compounds. These may be used singly or in admixture of two or more. Particularly preferable is a phenolic compound, a sulfur compound, or a combination of the phenolic compound and the sulfur compound.

Some of the fillers also serves as a flame retardant and a heat-resistant stabilizer. The carbon and phosphorus compounds also serve as a flame retardant and a heat-resistant stabilizer.

In the thermally conductive composition of the present embodiment, the total content of polymer components and a filler is preferably from 80 to 100% by mass, more preferably from 90 to 100% by mass, further preferably from 95 to 100% by mass. The content of the filler based on 100 parts by mass in total of polymer components is preferably from 500 to 2000 parts by mass, more preferably from 600 to 2000 parts by mass, further preferably from 700 to 2000 parts by mass, still further preferably from 800 to 2000 parts by mass.

The content of filler (A) surface-treated with a silylated castor oil derivative based on 100 parts by mass in total of polymer components is preferably from 100 to 1500 parts by mass, more preferably from 200 to 1200 parts by mass, further preferably from 300 to 1100 parts by mass, still further preferably from 400 to 1000 parts by mass. When the content of filler (A) surface-treated with the silylated castor oil derivative is 100 parts by mass or more, the amount of filler to be filled can be in large quantities, thereby enabling imparting of thermally conductive properties, and the content being 1,500 parts by mass or less makes it possible to give a thermally conductive composition in liquid form.

The content of filler (B) based on 100 parts by mass in total of polymer components is preferably from 500 to 1,900 parts by mass, more preferably from 800 to 1,800 parts by mass, further preferably from 900 to 1,700 parts by mass. When the content of filler (B) is 500 parts by mass or more, the thermally conductive properties can be increased, and when the content of filler (B) is 2,000 parts by mass or less, the thermal conductive composition can be made fluid and liquid.

The content ratio of a filler (A)+a filler (B) to the other fillers in the filler contained in the thermally conductive composition of the present embodiment is preferably from 100:1.5 to 100:0.25 and more preferably from 100:0.5 to 100:0.25 from the viewpoints of a viscosity and thermally conductivities of the composition.

### <Production of Thermally Conductive Composition>

The thermally conductive composition of the present embodiment is preferably in liquid form at room temperature (23° C.) from the viewpoints of handling and the filling properties of a filler.

The method for producing the thermally conductive composition of the present embodiment is not particularly limited. For example, a case in which a combination of a castor oil-based polyol and a polyisocyanate compound is used as polymer components, will be described.

When surface treatment in a filler (A) is performed by the integral blend method, for example, to the silylated castor oil-based polyol and the polyisocyanate compound are added a silylated castor oil derivative, an untreated filler, and a filler (B), and the mixture is kneaded while heating to from 80 to 120° C. The mixture is further kneaded while pressure is reduced, and once cooled to room temperature (23° C.). Then, a dispersant is added thereto and the mixture is further kneaded to enable a thermally conductive composition of the present embodiment to be obtained. Before kneaded with each of the components, the polyisocyanate compound may be allowed to react with a portion of the castor oil-based polyol to become an isocyanate-terminated prepolymer. The filler (A) surface-treated preliminarily with a silylated castor oil derivative by the dry method or wet method may be used.

Each of the components can be kneaded using a rotation-revolution stirring mixer, a blender, a nauta, a Henschel mixer, a planetary mixer, or the like.

When the polymer component constituting a urethane resin is blended into the thermally conductive composition of the present embodiment, the thermally conductive composition may be a two-component material composed of two components: a main component composed mainly of a polyol component; and a curing agent mainly composed of a polyisocyanate compound. A filler (A) may be contained in either the main component or the curing agent.

Mixing such a main component and a curing agent at the equivalent ratio [NCO/OH] described above enables the thermally conductive composition as a two-component material to be cured.

The viscosity at 23° C. of the thermally conductive composition of the present embodiment is preferably from 20 to 800 Pa·s, more preferably from 200 to 750, further preferably from 250 to 700, from the viewpoint of flowability. When the viscosity of the thermally conductive composition is 800 or less, sedimentation of the filler during preservation can be inhibited, and when the viscosity is 20 or more, printing and an application work can be performed while the coating thickness of the thermally conductive composition is made larger.

The consistency at 23° C. of the thermally conductive composition of the present embodiment is preferably from 250 to 400, more preferably from 255 to 395, further preferably from 255 to 390, from the viewpoint of flowability. When the consistency of the thermally conductive composition is 400 or less, sedimentation of the filler during preservation can be inhibited, and when the consistency is 255 or more, printing and an application work can be performed while the coating thickness of the thermally conductive composition is made larger.

The consistency herein is an index indicating the flexibility of a thermally conductive composition, and a larger value thereof indicates a softer thermally conductive composition.

The consistency can be measured by a method in accordance with JIS K2220:2013, and specifically can be measured by the method described in examples.

The consistency of the thermally conductive composition is preferably measured within 5 minutes after raw materials were mixed to obtain a thermally conductive composition, and for example, it is preferably measured within 5 minutes after all raw materials were added, or preferably within 5 minutes after a curing agent was added.

### <Curing Reaction of Thermally Conductive Composition>

The thermally conductive composition of the present embodiment is poured into a mold or the like, dried as required, and then cured under heating to thereby enable a cured product made of the thermally conductive composition to be obtained. The drying may be performed at normal temperature or may be natural drying. The heating is preferably performed at a temperature of 50 to 100° C. for 30 minutes to 20 hours, more preferably performed at a temperature of 60 to 90° C. for 1 to 10 hours.

The thermal conductivity of a cured product of the thermally conductive composition of the present embodiment is preferably 0.5 W/m·K or more, more preferably 1.0 W/m·K or more, further preferably 3.0 W/m·K or more. The thermal conductivity of the cured product can be set to 0.5 W/m·K or more by appropriately adjusting the type and content of the filler(s).

The thermal conductivity can be measured in accordance with ISO 20020-2, and specifically can be measured by the method described in examples.

The Asker C hardness of the cured product of the thermally conductive composition of the present embodiment measured in accordance with the hardness test (Type C) of JIS K7312:1996 is preferably from 10 to 95, more preferably from 10 to 90, further preferably from 20 to 90. When the hardness of the cured product is within the range, the cured product can have a moderate hardness.

The C hardness can be measured specifically by the method described in examples.

The A hardness of the cured product of the thermally conductive composition of the present embodiment measured in accordance with the hardness test (Type A) of JIS K7312:1996 is preferably from 30 to 97, more preferably from 35 to 95, further preferably from 40 to 95. When the hardness of the cured product is within the range, the cured product can have a moderate hardness.

The A hardness can be measured specifically by the method described in examples.

The manner in which the reaction occurs on giving the cured product of the thermally conductive composition varies depending on the type of polymer component as well and cannot be expressed unequivocally. The manner is widely varied, such as a reaction between a castor oil-based polyol and a polyisocyanate compound, a reaction between the castor oil-based polyol and a silylated castor oil derivative, and a reaction between the polyisocyanate compound and the silylated castor oil derivative, and thus it is not possible to comprehensively describe specific aspects based on such combinations. Accordingly, it can be said that direct identification of the cured product of the thermally conductive composition by its structure or characteristic is impossible or impractical.

With the thermally conductive composition of the present embodiment, it is possible to lower the hardness while maintaining the highly thermally conductive properties, and to give a cured product excellent in hydrolytic resistance. Accordingly, cured products of the thermally conductive composition of the present embodiment can be suitably used in heat generating electronic components such as electronic devices, personal computers, and ECUs and batteries for automobiles.

### EXAMPLES

Next, the present invention will be described concretely with reference to Examples, but the present invention is in no way limited to these Examples.

### 1. Details of Each Component

The details of each of components used for preparation of compositions, are as follows.

### [Polymer Component]

Polymer 1:

The following two components were blended in a composition to form a Polymer 1.
<Acrylic resin 1> ACRYCURE (R) HD-A218 (trade name, manufactured by Nippon Shokubai Co., Ltd.), viscosity at 25° C.: 150 mPa·s
<Curing agent 1> Perkadox (R) 16 (trade name, manufactured by KAYAKU NOURYON CORPORATION; bis(4-tert-butylcyclohexan-1-yl) peroxydicarbonate)

Polymer 2:

The following two components were compounded in a composition to form Polymer 2.
<Acrylic polyol 1> BPX-003 (trade name, manufactured by Negami Chemical Industrial Co., Ltd.), hydroxyl value: 48.4 mg KOH/g, non-volatile content: 98.6 wt %, viscosity at 25° C.: 1,670 mPa·s
<Polyisocyanate compound 1> Coronate (R) 2793URIC (trade name, manufactured by Tosoh Corporation; polyisocyanate in which polyhydric alcohol was added to a base isocyanate HDI); viscosity at 25° C.: 2,800 mPa·s; NCO content: 16.6% by mass

Polymer 3:

The following two components were compounded in a composition to form Polymer 3.
<Castor oil-based polyol 1> Hydroxyl value: 23.2 mgKOH/g, acid value: 3.3 mgKOH/g, viscosity at 25° C.: 78 mPa·s, moisture content: 0.01% by mass or less, the number of hydroxyl groups: 2
<Polyisocyanate compound 2> URIC N-2023 (trade name: manufactured by Itoh Oil Chemicals Co., Ltd., a prepolymer with terminal isocyanato groups (modified MDI)), viscosity at 25° C.: 2,290 mPa·s, NCO content: 16% by mass

The viscosities are values measured at 25° C. based on JIS Z8803:2011 “Methods for viscosity measurement of liquid” using a rotary viscometer. Specifically, the values were measured using a BM-type viscometer (manufactured by Toki Sangyo Co., Ltd.) at 25° C. under conditions of rotor Nos. from 1 to 7 and a rotation rate of 60 rpm.

### [Filler]

Filler 1 (alumina): AL45H (trade name, manufactured by Showa Denko K.K.), volume cumulative particle diameter D50: 3.0 μm, specific surface area: 1.2 m²/g
Filler 2 (alumina): AES-12 (trade name, manufactured by Sumitomo Chemical Company, Limited), volume cumulative particle diameter D50: 0.5 μm, specific surface area: 5.8 m²/g
Filler 3 (alumina): BAK-5 (trade name, manufactured by Shanghai Bestry Performance Materials Co., Ltd.), volume cumulative particle diameter D50: 5 μm, specific surface area: 0.4 m²/g
Filler 4 (alumina): AS-10 (trade name, manufactured by Showa Denko K.K.), volume cumulative particle diameter D50: 39 μm, specific surface area: 0.5 m²/g
Filler 5: Silicon-containing oxide-coated aluminum nitride; it was produced according to the following synthesis examples.

### Synthesis Examples

Using a vacuum desiccator that was made of an acrylic resin having a plate thickness of 20 mm, had inner dimensions of 260 mm×260 mm×100 mm, and had a structure having two, upper and lower, stages divided by a partition having through holes, 100 g of aluminum nitride (FAN-f30-A1 manufactured by Furukawa Denshi Co., Ltd., volume cumulative particle diameter D50 30 μm, specific surface area 0.12 m²/g) uniformly spread on a stainless tray was left to stand on the upper stage, and 30 g of 1,3,5,7-tetramethylcyclotetrasiloxane (manufactured by Tokyo Chemical Industry Co., Ltd.) placed in a glass petri dish was left to stand on the lower stage. Thereafter, the vacuum desiccator was closed and heated in an oven at 80° C. for 30 hours. The operation was performed with safety measures taken, such as release of hydrogen gas generated by the reaction from the open valve attached to the desiccator.

Next, the sample taken out of the desiccator was placed in an alumina crucible. The sample was subjected to heat treatment in the atmospheric air under conditions of 650° C. and 3 hours to obtain silicon-containing oxide-coated aluminum nitride. The volume cumulative particle diameter D50 of the resulting silicon-containing oxide-coated aluminum nitride was 30 μm, and the coverage of the silicon-containing oxide coating that covers the surface of the aluminum nitride as determined by LEIS analysis was 74%.

Note, however, the volume cumulative particle diameter D50 and specific surface area of each of fillers from 1 to 5 were those measured by the following method.

### <Volume Cumulative Particle Diameter D50>

The volume cumulative particle diameter D50 was determined from the particle diameter at an integrated volume of 50% (50% particle diameter D50) in the particle size distribution measured using a laser diffraction-type particle size analyzer (manufactured by MicrotracBEL Corp., trade name: MT3300EXII).

### <Specific Surface Area>

The specific surface area was measured using a specific surface area measurement apparatus (manufactured by Mountech Co., Ltd., trade name: Macsorb MS30) by the single point BET method based on nitrogen adsorption.

### [Heat-Resistant Stabilizer]

Heat-resistant stabilizer 1: AO-50 (trade name, manufactured by ADEKA Corporation): Octadecyl 3-(3,5-di-tert-butyl-4-hydroxyphenyl)propionate
Heat-resistant stabilizer 2: AO-412S (trade name, manufactured by ADEKA Corporation): 2,2-Bis{[3-(dodecylthio)-1-oxopropoxy]methyl}propane-1,3-diyl bis[3-(dodecylthio)propionate]

### [Antifoaming Agent]

Antifoaming agent 1: BYK-A535 (trade name, manufactured by BYK-Chemie GmbH)

### [Dispersant]

Dispersant 1: EXP6496D (trade name, manufactured by DIC Corporation: A polyester compound)

### 2. Production of Surface Treatment Filler

2-1. Production of Filler (Filler (A)) Surface-Treated with Silylated Castor Oil derivative

### Production Example 1-1

(1) A two-necked flask was charged with 100 g of a castor oil-based polyol (trade name “URIC H31”, molecular weight 342, manufactured by Ito Oil Chemicals Co., Ltd.), heated to 105° C. under reduced pressure for 2 hours to perform dehydration. Then after purging with nitrogen atmosphere, the flask was further charged with 5 mg of dioctyl tin monodecanate (trade name “Neostane U830”, manufactured by NITTO KASEI Co., Ltd.) and 60 g of (3-isocyanatopropyl)trimethoxysilane (manufactured by Tokyo Chemical Industry Co., Ltd.), and the reaction proceeded by stirring at 105° C. for 6 hours. The reaction was stopped after confirming the disappearance of isocyanato groups (2265 cm⁻¹) by infrared analysis to obtain a silylated castor oil derivative.
(2) 1 part by mass of the silylated castor oil derivative obtained above was added to 100 parts by mass of filler 1, placed in a rotation-revolution mixing mixer (manufactured by THINKY CORPORATION, trade name: ARV-310P), and stirred and mixed at a rotation speed of 1000 rpm for 30 seconds, a loosening operation was repeated 4 times, and the mixture was once air-dried.

Next, the air-dried mixture was heated in a hot air circulating oven at a temperature of 120° C. for 2 hours and then cooled to obtain a filler 1 surface-treated with the silylated castor oil derivative (hereinbelow denoted as “filler 1A”).

### Production Examples 1-2 and 1-3

Fillers 2 and 3 surface-treated with a silylated castor oil derivative (hereinbelow denoted as “filler 2A” and “filler 3A”, respectively) were obtained in the same manner as in Production Example 1-1, except that fillers 2 and 3 were used instead of filler 1.

2-2. Production of Filler Surface-Treated with One Other than Silylated Castor Oil Derivative

### Production Example 2-1

A value obtained by multiplying the specific surface area of filler 1 with 100 parts by mass of the blended amount of filler 1 and then dividing the product by the minimum area coated with decyltrimethoxysilane (product name “KBM-3013C”, manufactured by Shin-Etsu Chemical Co., Ltd.), was weighed as the content of decyltrimethoxysilane and added to 100 parts by mass of the filler 1, and water was added in an amount half of a value obtained by multiplying 100 parts by mass of filler 1 with the specific surface area of filler 1 and dividing the product by the minimum area coated with decyltrimethoxysilane, and the mixture was placed in a rotation-revolution mixing mixer (manufactured by THINKY CORPORATION, trade name: ARV-310P), and stirred and mixed at a rotation speed of 1000 rpm for 30 seconds, a loosening operation was repeated 4 times, and the mixture was once air-dried.

Next, the air-dried mixture was heated in a hot air circulating oven at a temperature of 120° C. for 2 hours and then cooled to obtain a filler 1 surface-treated with the decyltrimethoxysilane (hereinbelow denoted as “filler 1ds”).

### Production Examples 2-2 and 2-3

Fillers 2 and 3 surface-treated with decyltrimethoxysilane (hereinbelow denoted as “filler 2ds” and “filler 3ds”) were obtained in the same manner as in Production Example 2-1, except that fillers 2 and 3 were used instead of filler 1.

### 3. Production of Thermally Conductive Composition

### Example 1

To a container was added 100 parts by mass of acrylic resin 1, 500 parts by mass of filler 1A as a filler (A), and 500 parts by mass of filler 4 as a filler (B), and the mixture was dried in a hot air circulating oven at 100° C. for 30 minutes, and then stirred and mixed for 30 seconds at a rotation speed of 2000 rpm in a rotation-revolution mixing mixer.

Thereafter, the mixture was cooled to room temperature (23° C.), 1 part by mass of curing agent 1 was added, and the mixture was immediately stirred and defoamed in a rotation-revolution mixing mixer at a rotation speed of 2000 rpm for 30 seconds to obtain a thermally conductive acrylic resin composition.

### Example 2, and Comparative Examples 1 to 4

A thermally conductive acrylic resin composition of each Example and Comparative Example was obtained in the same manner as in Example 1, except that the components were replaced by each component of the type and amount blended described in Table 1.

### Example 3

To a container was weighed and added 71.8 parts by mass of acrylic polyol 1 and 2.0 parts by mass of dispersant 1, and the mixture was once placed in a rotation-revolution mixing mixer (manufactured by THINKY CORPORATION, trade name: ARV-310P), and stirred and mixed at a rotation speed of 1500 rpm for 30 seconds. Next, 400 parts by mass of filler 1A as a filler (A) and 400 parts by mass of filler 4 as a filler (B) were added, and the mixture was dried in a hot air circulating oven at 100° C. for 30 minutes, followed by stirred and mixed at a rotation speed of 2000 rpm for 30 seconds in the rotation-revolution mixing mixer.

Thereafter, the mixture was cooled to room temperature (23° C.), 26.2 parts by mass of polyisocyanate compound 1 was added, and the mixture was immediately stirred and defoamed with a rotation-revolution mixing mixer at a rotation speed 2000 rpm for 30 seconds to obtain a thermally conductive acrylic urethane resin composition.

### Example 4, and Comparative Examples 5 to 8

A thermally conductive acrylic urethane resin composition of each Example and Comparative Example was obtained in the same manner as in Example 3, except that the components were replaced by each component of the type and amount blended described in Table 2.

### Example 5

To a container was weighed and added 88.5 parts by mass of castor oil-based polyol 1 and 4.7 parts by mass of dispersant 1, and the mixture was once placed in a rotation-revolution mixing mixer (manufactured by THINKY CORPORATION, trade name: ARV-310P), and stirred and mixed at a rotation speed of 1500 rpm for 30 seconds. Next, 523.6 parts by mass of filler 1A as a filler (A) and 523.6 parts by mass of filler 4 as a filler (B) were added, and the mixture was dried in a hot air circulating oven at 100° C. for 30 minutes, followed by stirred and mixed for 30 seconds at a rotation speed of 2000 rpm in a rotation-revolution mixing mixer.

Thereafter, as the other components, 2.1 parts by mass of antifoaming agent 1, 2.1 parts by mass of heat-resistant stabilizer 1, and 2.1 parts by mass of heat-resistant stabilizer 2 were added, and the mixture was dried in a hot-air circulating oven at 100° C. for 30 minutes, followed by stirred and mixed at 2000 rpm for 30 seconds in a rotation-revolution mixing mixer.

The mixture was cooled to room temperature (23° C.), and 11.5 parts by mass of the polyisocyanate compound 2 were added thereto, and immediately thereafter, the resultant was defoamed by stirring in a rotation-revolution mixing mixer at a rotation speed of 2000 rpm for 30 seconds to obtain the thermally conductive urethane resin composition.

### Example 6 and Comparative Examples 9 to 12

The thermally conductive urethane resin composition of each of Examples and Comparative Examples was obtained in the same manner as in Example 5 except that the components were replaced by each component of the type and amount blended described in Table 3.

Note, however, blank columns in Tables 1 to 3 denote no compounds.

### 4. Evaluation

### 4-1 Consistency

The consistency was measured within 5 minutes after the thermally conductive compositions obtained in the Examples and Comparative Examples were obtained.

The consistency, which is a needle penetration by means of a ¼ cone described in JIS K2220:2013, was measured using an automatic needle penetration tester (manufactured by Rigo Co., Ltd., RPM-101).

### 4-2. Hardness

### (1) Preparation of Test Specimen for Evaluation

A silicone mold (diameter: 50 mm×depth: 30 mm, 6 cavities) was provided, and each defoamed composition was poured thereinto and left to stand for a day at room temperature (23° C.) to obtain test specimens (diameter: 50 mm×thickness: 8 mm).

### (2) Measurement

Measurement was performed by one of the following methods.
(i) The Asker C hardness of the test specimen was measured in accordance with JIS K7312:1996, using a durometer for rubber (manufactured by KOBUNSHI KEIKI CO., LTD., trade name: “Asker Durometer Type C”).
(ii) The Asker A hardness of the test specimen was measured in accordance with ASTM D2240, using a durometer for rubber (manufactured by KOBUNSHI KEIKI CO., LTD., trade name “Asker Durometer Type A”).

### 4-3. Thermal Conductivity

The thermal conductivity of the test specimen obtained by the above 4-2. (1) was measured in accordance with ISO 20020-2, employing a hot disk method thermophysical property measuring apparatus (manufactured by Kyoto Electronics Manufacturing Co., Ltd., product name TPS 2500 S).

The evaluation results are shown together in Tables 1 to 3.

TABLE 1

| Blended | | Example | Comparative | Comparative | Example | Comparative | Comparative |
|---|---|---|---|---|---|---|---|
| component | [Details] | 1 | Example 1 | Example 2 | 2 | Example 3 | Example 4 |
| Polymer 1 | HD-A218 | 100 | 100 | 100 | 100 | 100 | 100 |
| | Perkadox 16 | 1 | 1 | 1 | 1 | 1 | 1 |
| Filler (A) | Filler 1A | 500 | | | | | |
| | Filler 2A | | | | 400 | | |
| | Filler 3A | | | | 500 | | |
| Filler (B) | Filler 4 | 500 | 500 | 500 | | | |
| | Filler 5 | | | | 800 | 800 | 800 |
| Other | Filler 1 | | 500 | | | | |
| fillers | Filler 1ds | | | 500 | | | |
| | Filler 2 | | | | | 400 | |
| | Filler 3 | | | | | 500 | |
| | Filler 2ds | | | | | | 400 |
| | Filler 3ds | | | | | | 500 |
| Evaluation | Consistency | 289 | 273 | 289 | 109 | 98 | 100 |
| | (¼ cone) | | | | | | |
| | Hardness | 51 | 68 | 63 | 68 | 75 | 70 |
| | (Asker C) | | | | | | |
| | Thermal | 2.87 | 2.71 | 2.81 | 6.24 | 6.14 | 6.14 |
| | conductivity | | | | | | |
| | (W/m · k) | | | | | | |

* The numeral of the blended component denotes parts by mass.

According to the results of Table 1, it can be seen that the cured products of the thermally conductive acrylic resin compositions containing fillers from 1A to 3A that are fillers (A) surface-treated with a silylated castor oil derivative, can maintain or increase the consistency as well as lower the hardness while improving the thermally conductive properties, as compared with the cured products of the thermally conductive acrylic resin compositions containing fillers from 1 to 3 not surface-treated, or fillers from 1ds to 3ds surface-treated with an alkoxy silane (comparison of Example 1 with Comparative Example 1 or 2; of Example 2 with Comparative Example 3 or 4).

TABLE 2

| Compounded | | Example | Comparative | Comparative | Example | Comparative | Comparative |
|---|---|---|---|---|---|---|---|
| component | [Details] | 3 | Example 5 | Example 6 | 4 | Example 7 | Example 8 |
| Polymer 2 | BPX-003 | 71.8 | 71.8 | 71.8 | 71.8 | 71.8 | 71.8 |
| | Coronate | 26.2 | 26.2 | 26.2 | 26.2 | 26.2 | 26.2 |
| | 2793 | | | | | | |
| Dispersant 1 | EXP6496D | 2 | 2 | 2 | 2 | 2 | 2 |
| Filler (A) | Filler 1A | 400 | | | | | |
| | Filler 2A | | | | 400 | | |
| | Filler 3A | | | | 500 | | |
| Filler (B) | Filler 4 | 400 | 400 | 400 | | | |
| | Filler 5 | | | | 800 | 800 | 800 |
| Other | Filler 1 | | 400 | | | | |
| fillers | Filler 1ds | | | 400 | | | |
| | Filler 2 | | | | | 400 | |
| | Filler 3 | | | | | 500 | |
| | Filler 2ds | | | | | | 400 |
| | Filler 3ds | | | | | | 500 |
| Evaluation | Consistency | 320 | 318 | 275 | 168 | 130 | 118 |
| | (¼ cone) | | | | | | |
| | Hardness | 83 | 88 | 87 | 89 | 96 | 85 |
| | (Asker A) | | | | | | |
| | Thermal | 2.60 | 2.43 | 2.58 | 6.15 | 6.15 | 6.15 |
| | conductivity | | | | | | |
| | (W/m · k) | | | | | | |

* The numeral of the blended component denotes parts by mass.

According to the results of Table 2, it can be seen that the cured products of the thermally conductive acrylic urethane resin compositions containing fillers from 1A to 3A that are fillers (A) surface-treated with a silylated castor oil derivative, can maintain or increase the consistency as well as maintain or lower the hardness while improving or maintaining the thermally conductive properties, as compared with the cured products of the thermally conductive acrylic urethane resin compositions containing fillers from 1 to 3 not surface-treated, or fillers from 1ds to 3ds surface-treated with an alkoxy silane (comparison of Example 3 with Comparative Example 6 or 6; of Example 2 with Comparative Example 7 or 8). In particular, the large content of the filler results in significant increase in consistency and significant decrease in hardness (Example 4).

TABLE 3

| Compounded | | Example | Comparative | Comparative | Example | Comparative | Comparative |
|---|---|---|---|---|---|---|---|
| component | [Details] | 5 | Example 9 | Example 10 | 6 | Example 11 | Example 12 |
| Polymer 3 | Castor oil- | 88.5 | 88.5 | 88.5 | 88.5 | 88.5 | 88.5 |
| | based polyol 1 | | | | | | |
| | URIC N2023 | 11.5 | 11.5 | 11.5 | 11.5 | 11.5 | 11.5 |
| Dispersant 1 | EXP6496D | 4.7 | 4.7 | 4.7 | 4.7 | 4.7 | 4.7 |
| Filler (A) | Filler 1A | 523.6 | | | | | |
| | Filler 2A | | | | 418.8 | | |
| | Filler 3A | | | | 523.6 | | |
| Filler (B) | Filler 4 | 523.6 | 523.6 | 523.6 | | | |
| | Filler 5 | | | | 837.7 | 837.7 | 837.7 |
| Other | Filler 1 | | 523.6 | | | | |
| fillers | Filler 1ds | | | 523.6 | | | |
| | Filler 2 | | | | | 418.8 | |
| | Filler 3 | | | | | 523.6 | |
| | Filler 2ds | | | | | | 418.8 |
| | Filler 3ds | | | | | | 523.6 |
| Heat-resistant | AO-50 | 2.1 | 2.1 | 2.1 | 2.1 | 2.1 | 2.1 |
| stabilizer 1 | | | | | | | |
| Heat-resistant | AO-412S | 2.1 | 2.1 | 2.1 | 2.1 | 2.1 | 2.1 |
| stabilizer 2 | | | | | | | |
| Antifoaming | BYK-A535 | 2.1 | 2.1 | 2.1 | 2.1 | 2.1 | 2.1 |
| agent 1 | | | | | | | |
| Evaluation | Consistency | 342 | 333 | 295 | 255 | 231 | 178 |
| | (¼ cone) | | | | | | |
| | Hardness | 60 | 60 | — | 62 | 89 | — |
| | (Asker C) | | | | | | |
| | Thermal | 2.60 | 2.53 | — | 6.23 | 6.18 | — |
| | conductivity | | | | | | |
| | (W/m · k) | | | | | | |

* The numeral of the blended component denotes parts by mass.
* The evaluation “—” means “unmeasured” because of not being sufficiently cured.

According to the results of Table 3, it can be seen that the cured products of the thermally conductive urethane resin compositions containing fillers from 1A to 3A that are fillers (A) surface-treated with a silylated castor oil derivative, can increase the consistency as well as maintain or lower the hardness while improving or maintaining the thermally conductive properties, as compared with the cured products of the thermally conductive urethane resin compositions containing from fillers 1 to 3 not surface-treated, or fillers from 1ds to 3ds surface-treated with an alkoxy silane (comparison of Example 6 with Comparative Example 9 or 10; of Example 6 with Comparative Example 11 or 12).

Moreover, the compositions with fillers surface-treated with an alkoxysilane tend to have a smaller consistency.

Note that the compositions in Comparative Examples 10 and 12 were insufficiently cured.

1. A thermally conductive composition comprising a filler and a polymer component, wherein the filler comprises a filler (A) surface-treated with a silylated castor oil derivative obtained by reacting isocyanate silane with a castor oil-based polyol.

2. The thermally conductive composition according to claim 1, wherein the isocyanate silane comprises one or two selected from (3-isocyanatopropyl)triethoxysilane and (3-isocyanatopropyl)trimethoxysilane.

3. The thermally conductive composition according to claim 1, wherein the filler (A) has a volume cumulative particle diameter D50 of 0.03 to 10 μm.

4. The thermally conductive composition according to claim 1, further comprising, as the filler, a thermally conductive filler (B) not surface-treated with a silylated castor oil derivative.

5. The thermally conductive composition according to claim 4, wherein the filler (B) has a volume cumulative particle diameter D50 of 10 to 300 μm.

6. The thermally conductive composition according to claim 4, wherein the filler (B) is aluminum oxide, or aluminum nitride having a silicon-containing oxide coating on the surface thereof.

7. The thermally conductive composition according to claim 1, which is in liquid form.

8. The thermally conductive composition according to claim 1, wherein the polymer component is free of a silicone polymer, or a content of the silicone polymer in the polymer component is less than 50% by mass.

9. The thermally conductive composition according to claim 1, having a consistency at 23° C. of 250 to 400, measured in accordance with JIS K2220:2013.

10. A cured product of the thermally conductive composition according to claim 1.

11. The cured product according to claim 10, having a thermal conductivity of 0.5 W/mK or more, measured in accordance with ISO 20020-2.

12. The cured product according to claim 10, having an Asker C hardness of 10 to 95, measured in accordance with JIS K7132:1996.

13. An electronic component comprising the cured product according to claim 10.

14. The electronic component according to claim 13, wherein the electronic component is a heat dissipation sheet.
